(19) United States
(12) Patent Application Publication
(10) Pub. No.: US 2003/0027701 A1
(43) Pub. Date: Feb. 6, 2003

(54) Process for making a bag having a flat bottom, and bag made by said process

(75) Inventor: Ralph Drake, Milltown, NJ (US)

Correspondence Address: BROWDY AND NEIMARK, P.L.L.C., 624 NINTH STREET, NW, SUITE 300, WASHINGTON, DC, 20001-5303, US

(73) Assignee: SQUARE BOTTOM INC., Milltown, NJ

(21) Appl. No.: 10/211,292

(22) Filed: Aug. 5, 2002

(30) Foreign Application Priority Data
Aug. 3, 2001 (IT) MI2001A 001700

(51) Int. Cl. B31B 3/00

(52) U.S. Cl. 493/166

(57) ABSTRACT

Provided herein is a process consisting in: preparing a folded leaf (1) comprising a first main flap (1a) and a second main flap (1b) which overlap one another and a bottom edge (2) joining the main flaps (1a, 1b); tucking in the folded leaf (1) at the bottom edge (2) to form bellows including a first and a second base strip (3a, 3b) inserted between the main flaps (1a, 1b); making at the bellows short furrows (6), which are incised and welded and are spaced from one another, turning up a base strip (3a) on a main flap (1a) to form triangular pockets (7) at the short furrows (6); fixing the triangular pockets (7) to the base strips (3a, 3b); and separating each bag from the folded leaf (1).

### FIELD OF THE INVENTION

The present invention relates to a process for making a bag having a flat bottom, and to a bag made by said process. The bag is of the type used as a general-purpose carrier bag.

### DESCRIPTION OF THE PRIOR ART

As it is known, bags used as a general-purpose carrier bags, referred to as “SHOPPING BAGS”, or “T-SHIRT BAGS”, or “BOUTIQUE BAGS”, etc., are supplied to the customer as final packaging for the products purchased, even when the latter are already inserted in their own wrapping or packaging. In some cases, bags of considerable quality are used, so as to enhance the value of the products purchased.

For example, the final packaging of footwear or of various garments, which are already inserted in their own box-shaped wrappings, is a bag of the type referred to, which is well finished and purposely prepared.

A fundamental aspect of quality bags, which has a considerable influence both on their appearance and on their functionality, is that they have a flat bottom when the bags are being used.

A flat bottom, of rectangular or square shape, is important, in fact, both for accommodating the box-like packages or, anyway, the products to be carried in an orderly and capacious way and for keeping the side walls properly laid out, such as, for example, in bags made of leather, fabric or the like.

The orderly and square overall conformation and the well spread-out side walls also afford the advantage of ensuring maximum visibility for the distinctive signs of the points of sale, or for the advertising messages or various information of any type that may be printed on the bags.

Flat bottoms are frequently provided in paper bags. Paper, in fact, offers a certain stiffness and can be conveniently folded and arranged in flaps overlapping one another so as to form flat and square bottoms.

On the contrary, plastic material, especially a plastic material of small thickness, which is the type most widely used, does not have any stiffness and therefore bags made of plastic for which a flat and square bottom is desirable in general have bottoms the shape of which approaches only very approximately the flat one.

Bags which, albeit made of plastic material, have substantially flat bottoms are at present obtained only thanks to operations that are costly and far from satisfactory from various points of view.

It is, in fact, normally necessary to remove stretches or flaps of plastic material precisely in areas corresponding to the bottoms and then to carry out welding or joining.

These operations, at least in part, deprive the bags of homogeneity and resistance, in so far as the welding and the joining points generally remain evident, and since—above all—the welding forms areas of less resistance to stresses applied precisely in those parts of the bags—namely, the bottoms—that are subjected to the greatest stresses.

Furthermore, in general, bags made of plastic material, for which a bottom is required that is substantially flat and square, are only in part produced in an automated way. A part of the operations, namely the part that involves the operations of greater precision and complexity, in particular for removing stretches of plastic material and joining the incised edges, is entrusted to the manual intervention of specially trained staff.

There derive therefrom considerable costs and a relatively complex management of the operations of production and finishing of the bags, which in part are prepared in an automated way and then are entrusted to specially trained staff for their completion.

### SUMMARY OF THE INVENTION

In such a situation the technical task underlying the present invention is to devise a process for making a bag that has a flat bottom and is made of flexible laminar material, in particular plastic material, and a bag made in accordance with the process, which is capable of providing a substantial solution to the drawbacks of the prior art.

In the context of this technical task, an important purpose of the invention is to devise a process capable of making a flat bottom without weakening the resistance of the bottom itself in supporting the loads carried.

Another important purpose of the invention is to devise a process that will enable making a bag that is well finished and, in use, providing a bottom having a good square shape even when a thin plastic material is used.

A further purpose is to devise a process defined by steps that can be carried out in a totally automated way.

Yet another purpose is to devise a process that can be applied both to continuous sheets and to individual bags that are already in part pre-formed. Not the least important purpose of the invention is to make available a bag with a flat bottom, made according to said process, which will prove resistant, well finished and inexpensive to produce.

The process consists in: preparing a folded leaf comprising a first and a second main flap overlapping one another, and a bottom edge joining said main flaps; in tucking in said folded leaf at said bottom edge to form a first and a second base strip inserted between said main flaps, said base strips forming base edges with said main flaps; making, by means of cutting and welding at the margin of said cutting, short furrows, which extend between said base edges and said bottom edge and which are spaced from one another according to the size of a flattened bag; turning up a said base strip on a said main flap to form by turning inside out triangular pockets at said short furrows; fixing said triangular pockets to said base strips; and separating each bag from the folded leaf.

### BRIEF DESCRIPTION OF THE DRAWINGS

The characteristics and advantages of the Invention are clarified in what follows by the detailed description of preferred embodiments of the invention, provided with reference to the attached drawings, wherein:

FIG. 1 illustrates a step of the process in which a continuous folded leaf made of plastic material, illustrated in cutaway view and having two flaps set side by side, is partially tucked in, to form bellows;

FIG. 2 is a cross-sectional view of the folded leaf, already tucked in;

FIG. 3 illustrates, in elevation, a step of the process in which pre-folding impressions are prepared;

FIG. 4 illustrates the execution of a short furrow in the said folded leaf;

FIG. 5 is a partially perspective view of the folded leaf of FIG. 4;

FIG. 6 illustrates a step of turning inside out a portion of the bellows of the folded leaf of FIG. 5;

FIG. 7 is a partially perspective and cutaway view of the folded leaf of FIG. 6, with a portion of the bellows completely turned inside out;

FIG. 8 illustrates a step of separation of two consecutive bags and of fixing of flaps generated by the turning-inside-out process;

FIG. 9 is a perspective view from above of the final shape, i.e., prepared for use, of a portion of a bag made according to the process;

FIG. 10 is a perspective view from above of an initial step in obtaining the bag of FIG. 9, starting from the squashed condition of FIG. 8;

FIG. 11 illustrates an intermediate step of dilation of the bag; and

FIG. 12 is a perspective view from below of a last step of dilation of the bag, substantially achieving the open condition of FIG. 9.

### DESCRIPTION OF THE PREFERRED EMBODIMENTS

The process according to the invention enables operation on elements that are different from one another. For example, it is possible to make bags having flat bottoms starting from a strip of continuous plastic, which develops in a direction of a processing line and is divisible so as to enable formation of a large number of consecutive bags.

It is also possible to operate starting from individual small bags presenting a flattened tubular structure, each of which is substantially already made according to the size of a bag and is open on just one side, but still without any shaping on its bottom.

In this case, the individual bags are already separated from one another, and the flat bottom is obtained without need for making any incisions.

An intermediate situation is not ruled out, which is obtained starting from laminar material that is substantially already made according to the size of an individual bag, but is still open on three sides, like a sheet that is just folded back onto itself.

In the case which is illustrated in the figures and which is particularly suited for being applied industrially for large-scale production on a processing line, the operating steps are as described in what follows.

Initially, there is prepared a continuous folded leaf 1, made of laminar material such as a plastic material, capable of enabling the formation of a large number of consecutive bags.

The continuous folded leaf 1 is defined by a first main flap 1a and by a second main flap 1b set side by side one another and joined at a bottom edge 2. Preferably, the two flaps overlap one another and are spread out on a conveyor device.

In practice, the folded leaf 1 is obtained from a long sheet made of plastic material folded back on itself. However, the folded leaf 1 may also derive from two sheets that are initially separated and then joined together at the bottom edge 2, or again by a single long tubular element laid flattened out and then opened on three sides.

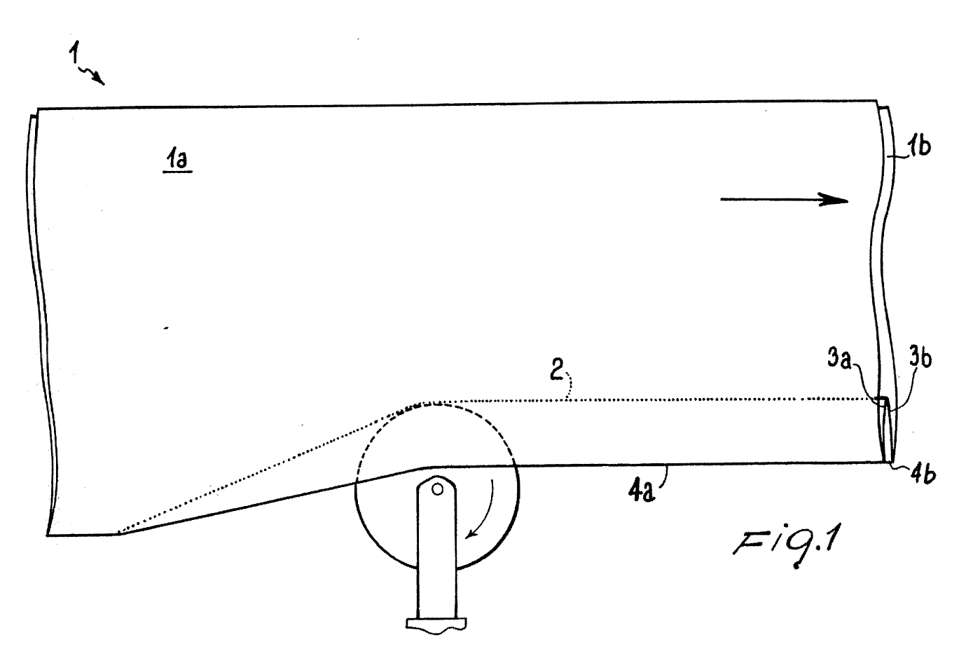

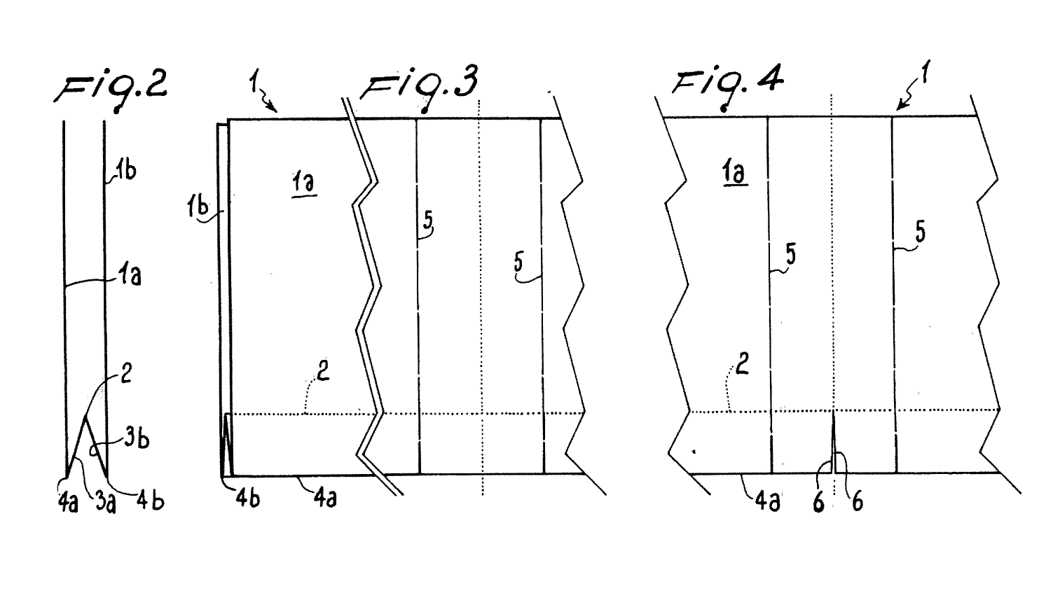

The folded leaf 1 undergoes various operations, and amongst these, there may be distinguished initially a step, illustrated in FIGS. 1 and 2, during which the folded leaf 1 itself is tucked in at the bottom edge 2 in order to form a first base strip 3a and a second base strip 3b joined at the bottom edge 2.

The first and the second base strips 3a and 3b overlap one another and are housed between the main flaps 1a, 1b so as to form a bellows.

The first base strip 3a is positioned immediately beneath the first main flap 1a, in contact therewith, whilst the second base strip 3b is positioned between the first strip 3a and the second flap 1b.

In the process of tucking in the base strips 3a, 3b in bellows fashion, there are defined, with the main flaps 1a and 1b respectively, a first base edge 4a and a second base edge 4b, parallel to one another and to the bottom edge 2. In an auxiliary step prior to or following upon the step of tucking in and forming the base bellows, there are made pre-folding impressions 5 on each main flap 1a, 1b oriented in a direction transverse to the bottom edge 2.

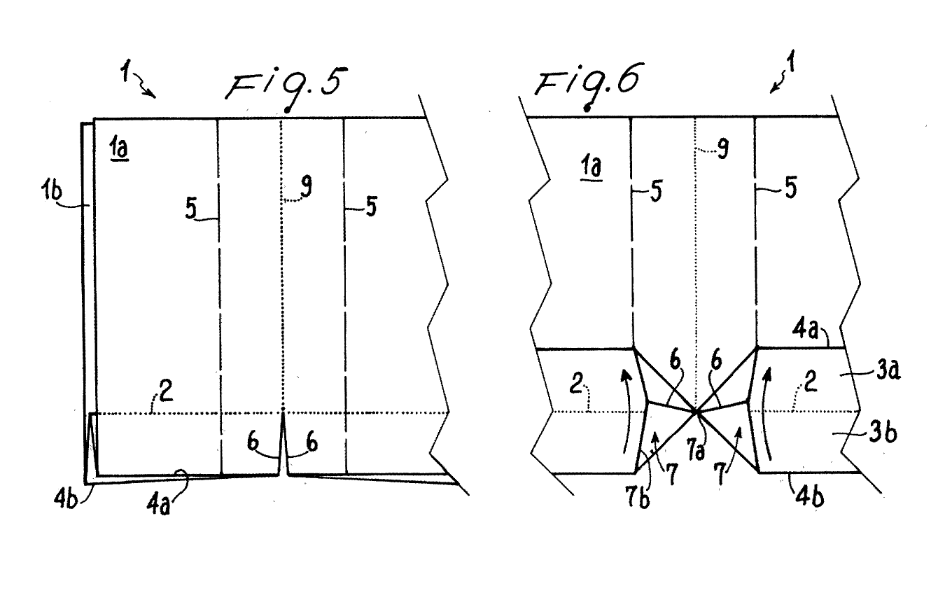

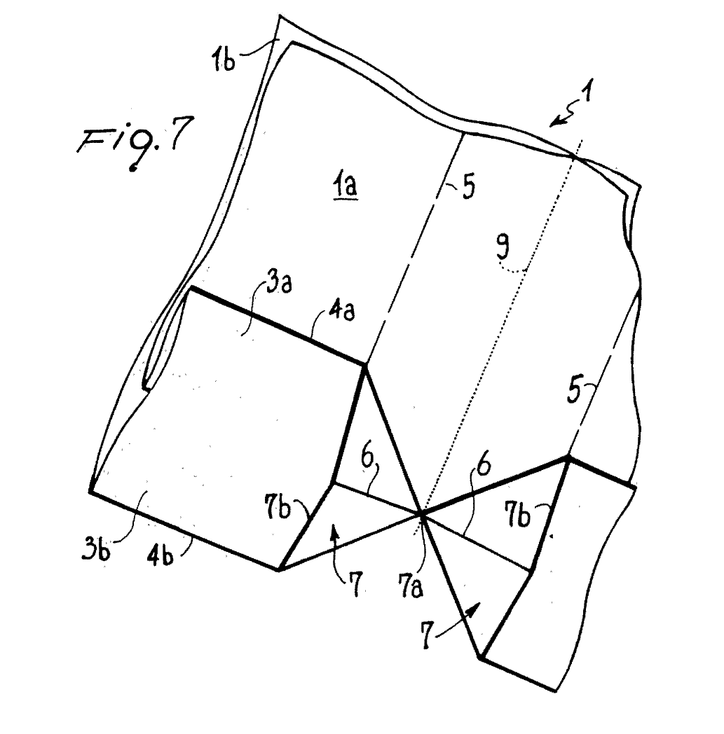

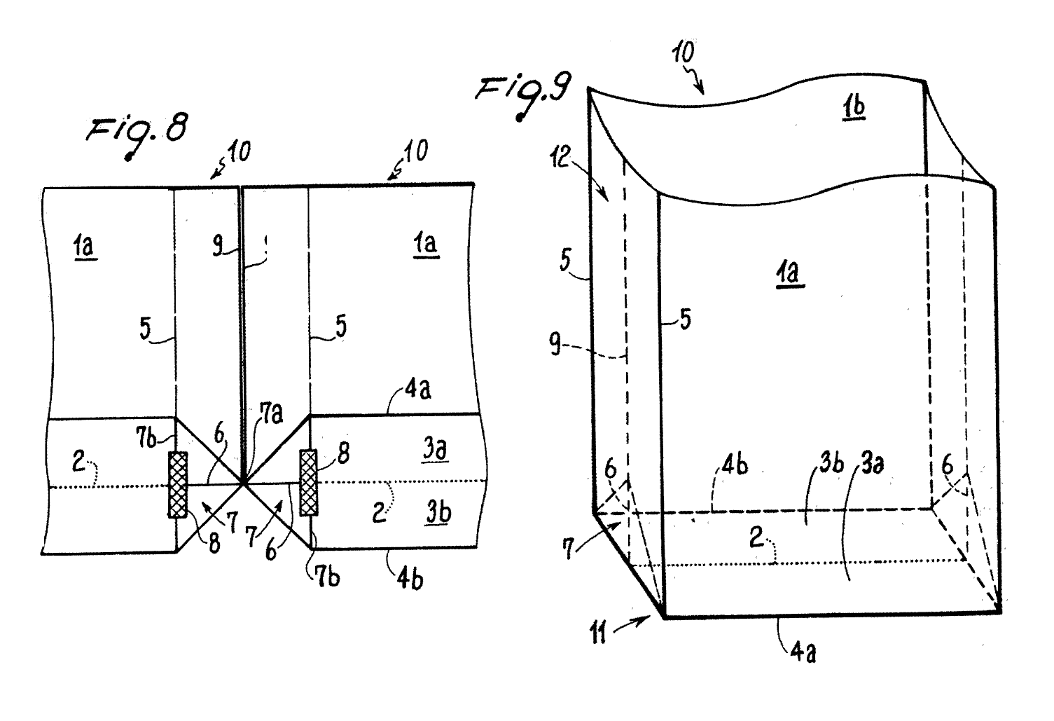

This auxiliary step is highlighted in FIG. 3 and is aimed at the formation of side bellows in the bags, as will be explained in detail in what follows.

In a subsequent step, illustrated in FIGS. 4 and 5, there are made, by means of cuts and welding, at the margin of the cuts, short furrows 6 extending between the base edges 4a, 4b, and the bottom edge 2.

The short furrows 6 define a first and limited stretch of separation between consecutive bags, and in fact they are set at a distance apart from one another by a pitch equal to the width of a flattened bag, in the direction of the bottom edge 2.

A feature of this step is the fact that the short furrows 6 are obtained by cutting both the main flaps 1a, 1b and the base strips 3a, 3b, and by welding together, both the main flaps 1a, 1b and the base strips 3a, 3b, at each side of the cuts.

In practice, the short furrows 6 are obtained by cutting and welding of the bellows made previously.

The above result may be obtained, with the folded leaf 1 made of plastic material, by adequately cutting, heating and pressing the cutting area.

It is possible that only the main flaps 1a, 1b, will be welded together, or even that no welding will be performed and that this operation will be put off to a subsequent step.

In a further step of the process, illustrated in FIGS. 6 and 7 and understandable also from FIG. 5, there is envisaged the step of turning up a base strip, in particular the first base strip 3a, on a main flap, in particular on the first main flap 1a.

With turning-up of the base strip, the base strips 3a and 3b set themselves aligned together. In addition, the said process of turning them up brings about a turning-inside-out of the end of the base strips 3a, 3b.

The turning-up of the first base strip 3a in fact partially draws along with it, on account of the presence of the short furrows 6, having welded margins or side lines, also part of the second base strip 3b. The welded margins at the short furrows 6 set themselves half way between the base strips.

In practice, the turning-up of the base strips 3a finally forms, as an immediate consequence, triangular pockets 7 at the short furrows 6.

The operations are preferably symmetrically performed upstream and downstream of each short furrow 6, so as to carry out the process in a single workstation both when partially completing a bag set downstream of a short furrow 6 and when operating on a new bag set upstream of the same furrow. Each of these triangular pockets 7 has a vertex 7a along the bottom edge 2 and a turning-inside-out rib or ridge 7b set at a distance from the vertex 7a and in a direction transverse to the bottom edge 2.

The triangular pockets 7 are then joined with the base strips 3a, 3b by means of a gluing operation, which may consist also of localized welding, or in applying an adhesive tape.

The above operation is preferably performed at the turning-inside-out rib 7b, so as not to leave edges open. The areas of gluing are indicated by impressions 8, which are clearly illustrated in FIG. 8. The gluing can, however, be pre-arranged in other points of the triangular pockets 7.

Finally, the last step of the process consists in isolating and separating each bag of the folded leaf 1 from the folded leafs immediately adjacent thereto by cutting the main flaps 1a, 1b and welding the margins of the cuttings, as illustrated in FIG. 8.

There are thus obtained side edges 9 of the folded leaf, developing in a direction transverse to the bottom edge 2 and set at a distance apart from one another according to the maximum width of a flattened folded leaf, designated as a whole by the number 10.

The already mentioned pre-folding impressions 5, made for facilitating the formation of side bellows, are set at a distance apart from side edges 9 according to the distance of said turning-inside-out ribs 7b from the respective said vertices 7a.

The entire process does not envisage steps of removal of flaps of plastic material.

As has already been said, the process can be applied also to folded leaves which are already according to the size of an individual bag 10, open on three sides like a folded sheet, or else already closed on three sides like an envelope.

In the case of a folded leaf open on three sides like a folded sheet, it is envisaged that immediately after the step of tucking in and forming the base bellows, the side edges 9 will be welded to obtain the same side edges 9 closed already before the step of turning up a base strip.

In practice, the preceding final step is carried out before the operations that lead to the production of the pockets 7, and it is not necessary to carry out the step of formation of the short furrows 6.

When, instead, a tubular leaf is initially prepared, closed on three sides like an envelope, also the operations of welding at the side edges 9 can be omitted. The necessary steps are those of tucking in said folded leaf at the bottom edge 2 to form a first strip 3a and a second base strip 3b, the turning-up of just one base strip 3a with the formation of the triangular pockets 7, and the fixing of the triangular pockets 7 to the base strips 3a, 3b.

The bag 10 is illustrated in FIG. 9 and can be obtained from the squashed shape illustrated in FIG. 8 by means of a series of successive dilations, illustrated in FIGS. 10,11, and 12.

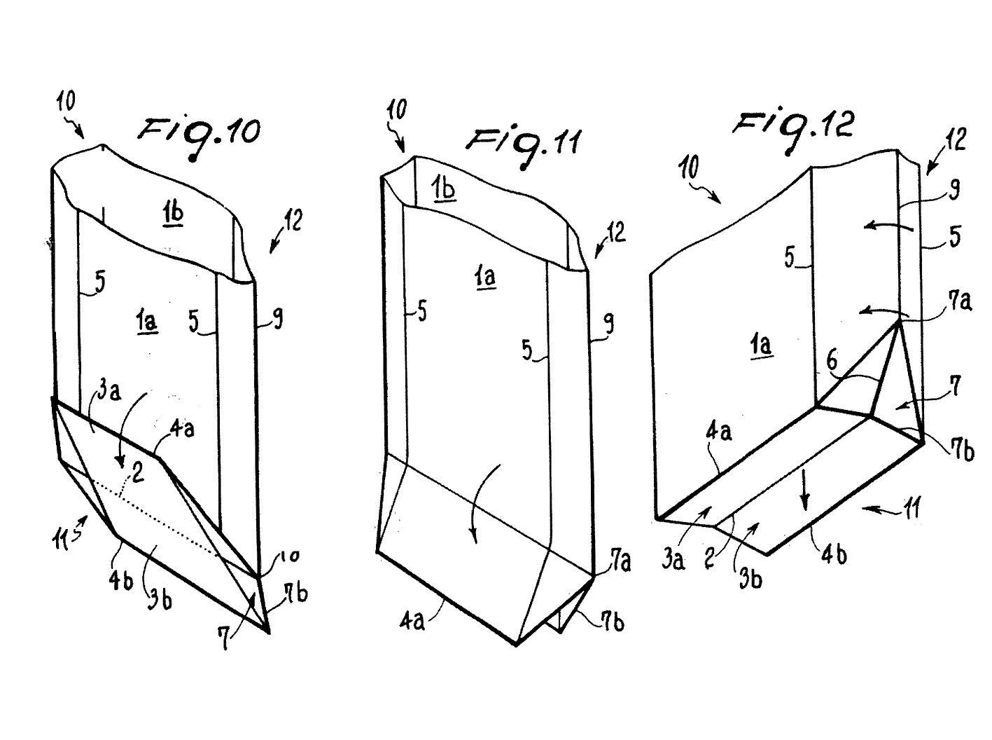

In particular, in FIGS. 10 and 11 the turned-up base strip 3a is brought onto the other base strip 3b that is not turned up and hence, by working from inside the bag 10, the bottom edge 2 is lowered so as to arrange the two base strips 3a, 3b substantially coplanar, as indicated in FIG. 12. Simultaneously, the side edges 9 are squashed between the pre-folding impressions 5 to provide volume to the bag 10 and to raise the pockets in the form of a triangle 7.

As a whole, the bag 10 obtained has a rectangular bottom 11, defined by the two base strips 3a, 3b, a mouth with possible supporting and closing means, which are not illustrated because they do not regard the present invention, two main faces 1a, 1b, and two side bellows 12 developing throughout the height of the bag, between the bottom 11 and the said mouth.

A characteristic of the bag 10 is that of having the main faces 1a, 1b and the bottom 11 defined by a continuous band and made of a single piece, without incisions and welding, so that it is substantially shaped like a pocket.

In fact, in the bag 10 once formed and dilated, the folded portions, i.e., the said triangular pockets 7, are situated on the side bellows 12 adjacent to the bottom 11, as illustrated in FIGS. 9 and 12.

The invention achieves important advantages.

In fact, it provides a manufacturing process and a bag made applying the process, that are distinguished in that a flat and square bottom 11 is obtained even when thin and flexible materials, such as plastic sheets, are used. The bottom 11 then presents, in use, a substantially stable, flat and square conformation, also on account of the fact that the triangular pockets 7 naturally keep the bottom itself in a spread-out and flattened condition.

In use, the triangular pockets 7 are in fact set at the sides of the bottom 11 and, since they are made up of a plurality of folded portions of the bag 10, present a substantial rigidity, which influences the shape of the bottom 11, as is evident also from FIG. 9.

Once completed, the bag 10 has a solid and well-finished appearance and structure because the bottom 11 is made of a single piece without any joins with the main faces 1a, 1b.

As has been said, in fact, the main faces 1a, 1b and the bottom 11 define a continuous pocket that is able to withstand even considerable weights. When, then, the bag 10 is made starting from a tubular leaf that is already closed on three sides, it is completely free from incisions and joins of said incisions.

When, instead, the bag 10 is made starting from a continuous folded leaf, as illustrated in the figures, the necessary separation of the consecutive bags leads to an incision and a concomitant welding developing centrally at the side bellows 12, at the side edges 9.

This welding does not substantially constitute a negative element because it is hidden by the bellows-like shape of the side walls and above all because the lifting stresses are withstood mainly by the main faces 1a, 1b and by the bottom 11.

The production process can finally be entirely and conveniently automated because the steps of the process are in themselves simple, easily distinguishable, and can be carried out consecutively in time, and also because the operations are facilitated in that no rejection of portions of the sheets is at all envisaged.

1. Process for making a bag having a flat bottom, consisting in:
preparing a folded leaf (1) comprising a first main flap (1a) and a second main flap (1b) overlapping one another, and a bottom edge (2) joining said main flaps (1a, 1b);
tucking in said folded leaf (1) at said bottom edge (2) to form a first and a second base strip (3a, 3b) inserted between said main flaps (1a, 1b), said base strips (3a, 3b) forming base edges (4a, 4b) with said main flaps (1a, 1b);
making, by means of cutting and welding margins of said cutting, short furrows (6) extending between said base edges (4a, 4b) and said bottom edge (2), and spaced from one another according to the size of a flattened bag;
turning up a said base strip (3a) on a said main flap (1a) to form by turning inside out triangular pockets (7) at said short furrows (6);
fixing said triangular pockets (7) to said base strips (3a, 3b); and
separating each bag (10) from said folded leaf (1).

2. Process according to claim 1, in which each bag (10) is separated from said folded leaf (1) by means of cutting said main flaps (1a, 1b) and welding margins of said cutting, for making side edges (9) set transverse to said bottom edge (2).

3. Process according to claim 1, in which pre-folding impressions (5) are made on each said main flap (1a, 1b) oriented in a direction transverse to said bottom edge (2).

4. Process according to claim 1, in which said short furrows (6) are performed by cutting said main flaps (1a, 1b) and said base strips (3a, 3b) and by welding together said main flaps (1a, 1b) and said base strips (3a, 3b) at margins of said cutting.

5. Process according to claim 1, in which said folded leaf (1) is worked at each short furrow (6) so as to complete partially a bag set downstream of said short furrow (6) and make simultaneously a part of a bag set upstream of said short furrow.

6. Process for making a bag having a flat bottom, consisting in:
preparing a folded leaf (1) having side edges (9) spaced from one another according to the size of a flattened bag and comprising a first and a second main flap (1a, 1b) overlapping one another, and a bottom edge (2) joining said main flaps (1a, 1b);
tucking in said folded leaf (1) at said bottom edge (2) to form a first and a second base strip (3a, 3b) inserted between said main flaps (1a, 1b);
welding said side edges (9) of said folded leaf (1);
turning up a said base strip (3a) on a said main flap (1a) to form by turning inside out triangular pockets (7) at said side edges (9); and
fixing said triangular pockets (7) to said base strips (3a, 3b).

7. Process for making a bag having a flat bottom, consisting in:
preparing a folded leaf (1) shaped like a flattened tubular element closed on three sides, comprising a first and a second main flap (1a, 1b) overlapping one another, and a bottom edge (2) and side edges (9) joining said main flaps (1a, 1b);
tucking in said folded leaf (1) at said bottom edge (2) to form a first and a second base strip (3a, 3b) inserted between said main flaps (1a, 1b);
turning up a said base strip (3a) on a said main flap (1a) to form by turning inside out triangular pockets (7) at said side edges (9); and
fixing said triangular pockets (7) to said base strips (3a, 3b).

8. Bag comprising a flat bottom (11), a mouth, main faces (1a, 1b) and side bellows (12), said main faces (1a, 1b) and said flat bottom (11) forming a laminar band that is substantially continuous and is made of a single piece, substantially shaped like a pocket, folded portions (7) being provided between said flat bottom (11) and said side bellows (12).

9. Bag according to claim 8, in which said folded portions (7) are arranged in said side bellows (12), adjacent to said flat bottom (11).

10. Bag according to claim 9, in which said folded portions (7) have a triangular shape.
